(19) United States
(12) Patent Application Publication
(10) Pub. No.: US 2011/0196776 A1
(43) Pub. Date: Aug. 11, 2011

(54) METHOD FOR FACILITATING EXCHANGE OF CONSUMER DATA

(75) Inventors: Jacob Rash, Gilbert, AZ (US); Richard Simon, Mesa, AZ (US)

(73) Assignee: Freehold Capital, Inc., Mesa, AZ (US)

(21) Appl. No.: 13/021,859

(22) Filed: Feb. 7, 2011

Related U.S. Application Data
(60) Provisional application No. 61/302,308, filed on Feb. 8, 2010.

(51) Int. Cl. G06Q 40/00

(52) U.S. Cl. 705/37

(57) ABSTRACT

A method for facilitating the exchange of consumer data between consumers and providers is disclosed. The method includes collecting and storing consumer supplied data on a computer network, providing the consumer supplied data to one or more providers, providing consumer personal data to a provider having the highest bid, collecting the bid amount from the provider having the highest bid and providing a portion of the collected bid amount to the consumer.

### CROSS REFERENCE TO RELATED APPLICATION

The present invention claims the benefit of the priority of the filing date of U.S. provisional patent application No. 61/302,308, filed Feb. 8, 2010, the entire contents of which is incorporated herein for all purposes.

### FIELD OF THE INVENTION

The present invention relates generally to the field of consumer data exchange and particularly to a sales lead auction-based system providing monetary benefit to a consumer in exchange for the release of personal data.

### BACKGROUND OF THE INVENTION

Auctions have historically provided a venue for the sale of goods. Modern auctions are often computer generated and facilitated via the internet so that they allow for the simplified exchange of goods between individuals located around the world. Goods sold at auction are sold at prices set by interested buyers. While auctions are commonly associated with the sale of goods and services, an auction process may prove useful for the sale of other intangible items that retain value, such as information.

One type of information that carries a certain level of value is personal data. As an example, personal information in the form of sales leads is constantly bought and sold as a valuable commodity between lead generators and those in the business of providing goods and services to consumers. More specifically, to have access to information identifying consumers that are interested in the purchase of a good or service and to have further access to personal contact and financial information for those identified consumers is an extremely valuable commodity. Generally, a lead generator is in receipt of the reward for providing such information in the form of a sales lead to a provider of goods or services. Most consumers are not even necessarily aware that their personal information is being traded between individuals in the sales lead industry. While the consumer is the rightful of owner of their personal information, they receive no benefit from the trading of such information.

The consumer is thus eliminated from transactions involving their own personal information and as a result, many of the leads generated from lead trading are not always reliable. Lead reliability is a major problem for the industry. Many of the leads that are sold are not serious about receiving a quote. These leads cost businesses in that they have paid for information and the information is inaccurate and thus provides zero value.

Another industry problem is the number of leads being sold to multiple providers of goods or services. Although lead generators may insist that they only sell their leads to two, three or four goods or services providers, the reality is that they usually end up in the hands of many more goods or services providers. While the lead generators may be rewarded with substantial profit for over-selling a lead, providers of goods or services are left to compete with numerous other providers, thereby reducing the value of the information they purchased. Even if a provider discovers this multiple sales activity, lead generators generally do not refund the amount paid for the lead.

U.S. Patent Application Publication No. 2006/0041500 discloses an auction system for leads wherein sales leads are auctioned by lead generators and purchased by providers of goods and services. However, the lead generators are provided with the funds in the event of a successful auction and the consumers whose information has been sold receives no portion of the auction proceeds.

Notwithstanding the above, there remains a need for a sales lead marketing system that provides consumers with remuneration in exchange for their personal information. Further, there is a continued need for a system that facilitates the direct exchange of information between consumers and providers of goods and services so that the need for a lead generator is eliminated.

### SUMMARY OF THE INVENTION

The present invention addresses one or more of the above needs by providing a method for facilitating the exchange of information between consumers and providers comprising the steps of collecting and storing consumer supplied data on a computer network, providing the consumer supplied data to one or more providers, providing consumer personal data to a provider having the highest bid, collecting the bid amount from the provider having the highest bid and providing a portion of the collected bid amount to the consumer.

In one aspect, collecting and storing the consumer supplied data may include one or more consumers providing needs data via a website and one or more consumers providing personal data via a website. The consumer may receive a consumer score based upon the value of the personal data wherein the consumer scores are computer generated and based upon the consumer's likelihood of purchasing any goods or services requested. Providing consumer supplied data to one or more providers may include one or more providers viewing needs data via a website of one or more consumers seeking services or goods provided by the provider. The provider may also view consumer scores via a website of one or more consumers seeking services or goods provided by the provider; and one or more providers may provide bid amounts for purchase of consumer personal data.

Additional aspects of the methods taught herein include the ability of a provider who provides the highest bid amount to provide results data via a website. The results data may be positive results data if the consumer personal data received by the provider resulted in a purchase of goods or services from the provider. The results data may be negative results data if the consumer personal data received by the provider did not result in a purchase of goods or services from the provider. The results data may then be used to generate consumer scores so that positive results data generates an increased consumer score and negative results data generates a decreased consumer score. Further, any consumer having an increased consumer score results in that consumer receiving an increased portion of the collected bid amount. The consumer score may reflect the frequency of needs data provided by a consumer, the frequency of positive results data for a consumer, the frequency of negative results data for a consumer, the accuracy of personal data provided by each consumer, or any combination thereof.

The auction system may be facilitated so that a consumer can either choose to accept or refuse a suggested bid amount. The consumer may also provide a suggested minimum bid amount. Any provider bid amount below the consumer's suggested bid amount may be automatically refused.

The auction system may also include a listing of provider product data wherein the provider product data includes a list of goods and services provided by one or more providers.

In a second aspect, the invention disclosed herein contemplates a website including a consumer interface and a provider interface. The consumer interface may include a first data entry location providing for the entry of consumer needs data. The consumer interface may also include a second data entry location providing for the entry of consumer personal data. The provider interface may include a first data access location wherein the data includes consumer needs data. The provider interface may include a second data access location wherein the data includes consumer scores. The provider interface may include a bid entry location wherein the provider provides bid amounts in attempt to gain access to consumer personal data. The provider interface may include a third data access location wherein only the provider providing the highest bid amount can access consumer personal data. The provider interface may include a result data entry location wherein the results data includes whether a consumer purchased goods or services from a provider.

The consumer interface may further include a third data entry location for providing a minimum bid amount requirement. The consumer interface may include a bid review location wherein a consumer can accept or refuse a bid amount. The consumer interface further includes a data access location wherein the data includes consumer scores. The consumer interface may include a fourth data entry location for contesting any results data. The consumer interface further includes a limited access option location wherein a consumer may limit the providers having an option to bid on a consumer's personal data. The consumer interface may include a proceeds access location wherein funds earned from a successful bid can be retrieved by a consumer.

### BRIEF DESCRIPTION OF THE DRAWINGS

FIG. 1 is a block diagram showing an example consumer data auction system as disclosed herein.

FIG. 2 is a block diagram showing an example consumer registration and participation process in accordance with the present invention.

FIG. 3 is a block diagram showing an example auction compensation model in accordance with the present invention.

### DETAILED DESCRIPTION

In general, the teachings herein provide for a method for facilitating the exchange of consumer data between consumers and providers. The method includes collecting and storing consumer supplied data on a computer network, providing the consumer supplied data to one or more providers, providing consumer personal data to one or more providers having a highest bid amount, collecting the bid amount from the provider having the highest bid and providing a portion of the collected bid amount to the consumer.

Consumer data may be collected via a website. A consumer may provide consumer data through one or more data entry locations. The one or more data entry locations may include a questionnaire format for ascertaining consumer personal data. Consumer personal data may include one or more of a consumer's name and relevant contact information (e.g., mailing address, phone number). Consumer personal data may also include more sensitive information including date of birth, social security number, annual income, credit rating and other data that may be required by certain services providers. For example, a provider in the business of providing mortgages may have a minimum credit rating upon which they are willing to bid for consumer personal data.

The one or more data entry locations may also include a questionnaire format for determining consumer needs data. Consumer needs data may include the type of goods or services being sought by the consumer. The needs data may be supplied by a consumer via a pre-set menu so that the consumer may only select from specific goods or services being currently offered. The consumer needs data may also be supplied via a free-form text box so that prospective providers may view the exact type of goods and/or services being sought by consumers. The consumer needs data may also include a location for selecting from a pre-set menu the general category of goods or services sought by a consumer while further including a free-form text box to specify with additional detail the type of goods or services requested. As an example, a consumer may select the category of automobiles while further specifying the specific make and model of automobile the consumer is looking to purchase. The consumer needs data may include multiple pre-set menus for narrowing the type of goods or services sought by a consumer. As an example, a consumer looking to purchase an automobile may encounter a first menu where they may select either “goods” or “services”. After selecting “goods”, an additional menu may include a listing of goods, including a category for “automobiles”. After selecting “automobiles”, an additional menu may list various automobile manufacturers and an additional menu may list various automobile models sold by the manufacturer selected. Additional menus may further narrow the goods by selecting a model year, price range, vehicle specifications, location, and any other variable that may help to further narrow the type of good sought by a consumer.

The consumer needs data entered by and collected from one or more consumers may then be stored in a database for viewing by one or more providers. A consumer may also select to have their consumer needs data and/or consumer personal data to be provided to one or more provider mailing or calling lists. Doing so may entitle the consumer to payment in exchange for agreeing to be added to a mail and/or call list. The payment may be a flat rate payment. The payment may increase based upon the number of mail and/or call lists that the consumer agrees to be added to. The payment may be provided to the consumer on a monthly, quarterly, or yearly basis. The payment may reflect (e.g., may be proportional to) the amount of revenue generated by the sale of their consumer personal data.

Upon consumer registration, the consumer may choose to be notified as opportunities arise for sale of their consumer personal data to be provided for purposes of a mail and/or call list. The notification may include details regarding the entity to which the consumer personal data may be sold. The notification may include information regarding the type of goods and/or services provided by the entity purchasing the consumer personal data for their mail and/or call lists. This information may be provided so that a consumer may better determine their interest level in being contacted by a particular entity.

The consumer needs data may be viewed by one or more providers via a first data access location. The first data access location may include one or more search parameter entry locations so that a provider may select search parameters that will show a listing of all consumers seeking a good or service provided by that provider. Additional search parameter entry locations may also be available so that the listing of consumers will be further narrowed by one or more additional limitations. As an example, a provider who provides mortgage services may enter search parameters to identify all consumers who have provided consumer needs data to indicate that they are seeking mortgage services. That provider may enter additional search parameters to further limit the resulting consumer listing. The listing may be limited, for example, by searching only for consumers seeking a refinancing loan, or by searching for consumers seeking a loan for less than $300,000.

Providers may also select to receive notification when a consumer provides consumer needs data that corresponds with goods and/or services provided by the provider. Upon registration, a provider may provide preferences data regarding the goods and/or services they provide and the types of consumers from whom they may be interested in purchasing consumer personal data from. Thus, provider emails may be automatically generated and sent when consumers matching the provider provided preference data place their consumer personal data up for auction.

Once a provider has identified one or more consumers that have provided consumer needs data that corresponds with the type, quality and quantity of goods and/or services provided by that provider, the provider may access a bid entry location. The bid entry location allows for the provider to provide a bid amount in an effort to access consumer personal data by providing a winning bid amount. The bid entry location may list the current highest bid amount and the date and time of bid end. Upon entering a bid, the provider may be notified when their bid is no longer the highest bid amount.

If a provider has provided a highest bid amount at bid end, the highest bid amount may then be collected from that provider. Multiple providers may provide a highest bid amount. Once the highest bid amount is collected, the provider providing that highest bid amount may gain access to the consumer personal data the provider had provided the bid for. A portion of the collected highest bid amount may then be provided to the consumer providing the consumer personal data. The consumer providing the consumer personal data may not receive their portion of the highest bid amount until a transaction has taken place between the consumer and at least one provider. The consumer may not receive their portion of the highest bid amount until proof of a successful transaction can be provided.

The consumer may receive their allotted portion of the highest bid amount in multiple disbursements. As an example, a consumer may receive a portion of the highest bid amount immediately upon collection of the highest bid amount from a provider. A consumer may receive an additional portion of the highest bid amount once they receive a quote from a provider. The consumer may receive an additional portion of the highest bid amount. One or more of the disbursements of the highest bid amount may be contingent upon submission of results data.

It should be noted that the consumer personal data and consumer needs data provided to a provider at any time (including for the purposes of mailing and/or calling lists) may include all of the information provided by the consumer and stored on the computer network or only a portion of the information provided by the consumer and stored on the computer network. As an example, in selling consumer personal data for use in a mailing list, only the consumer's name and address may be provided with no access to more sensitive data such as birth date or credit rating.

The auction process may allow for multiple winning bids so that multiple providers may receive consumer personal data from one consumer. The consumer may then have a choice of multiple providers from which to purchase goods or services. The bid proceeds collected by a consumer may also increase based upon the number of winning bets allowed and the number of providers to whom the consumer personal data is provided.

Consumer personal data may retain different levels of value depending on a number of variables. As an example, the consumer personal data of a consumer seeking to secure a home loan may have more value than the consumer personal data of a consumer seeking flooring for one room of a home (e.g., a lead for a high cost good or service may be more valuable than a lead for a lower cost good or service). As a further example, the consumer personal data of an individual who has purchased goods and/or services from one or more providers in the past may be worth more than the consumer personal data of an individual who has auctioned personal data on prior occasions but has never actually purchased any goods or services from a provider.

Advantageously, the present invention provides for a consumer score aspect so that providers may more easily identify the relative value of consumer personal data. A consumer score may be provided for each consumer who provides consumer personal data for auction. The consumer score may be devised by determining the likelihood that a lead will result in a sale of goods or services. More specifically, a consumer that has previously purchased goods and/or services from a provider may have an increased consumer score, whereas a consumer who has not previously participated in any consumer personal data auction may have a lower consumer score. Further, a consumer who repeatedly participates in consumer personal data auctions but has never actually purchased any good or service as a result of the auction may also have a lower consumer score.

In order to determine a consumer score, a provider may have an opportunity after the auction transaction has completed to provide results data for a consumer. The results data may be in the form of a questionnaire to ascertain the success level of the lead produced by the auction. More specifically, a provider may provide information regarding whether the consumer personal data upon which the provider successfully bid resulted in a sale of goods or services. The provider may further provide information on the level of interaction between the provider and the consumer (e.g., did the consumer communicate with the provider in an attempt to agree on a sale for goods or services or did the consumer provide no response after auction end). The resulting consumer score may be accessed and viewed by other providers to form a basis for the relative value of the consumer personal data associated with that consumer. As an example, a particular auction for consumer personal data may result in a sale of a good or service. The provider of that good or service (the first provider) may respond with positive results data in regard to that transaction. The consumer score associated with the purchasing consumer may then increase. In a subsequent auction, a second provider may view the increased consumer score and determine that the value of the consumer personal data for that consumer is high based on the previous purchase. Thus, the second provider may provide a higher bid for the consumer personal data based on the increased consumer score and a perceived increased likelihood that a successful bid may result in an eventual sale.

Further, a consumer score may take into account the relative value of the goods or services being sought. As mentioned above, certain transactions may have a higher value and will thus be worth more than other transactions to providers. Thus, a consumer who provides consumer needs data for a good or service with a high dollar value may show an increased consumer score as compared to a consumer who provides consumer needs data for a good or service with a low dollar value.

As the value of consumer personal data may affect bid price and subsequently affect the amount of bid proceeds realized by a consumer, a consumer may have the opportunity to provide consumer score feedback regarding their consumer score. A consumer may be provided with a follow-up questionnaire to provide results data regarding the interaction with one or more providers post-auction. The consumer may provide proof of purchase of the good or service requested via the consumer needs data. The consumer may provide a reason for the decision not to purchase from a particular provider. The consumer may provide details of any mitigating circumstance to explain any negative results data that the consumer may have received from one or more providers. A consumer may thus receive an increase to their consumer score based on their willingness to provide further detail regarding a transaction or lack thereof.

The invention described herein may include additional means for generating additional consumer payments. An existing consumer may provide basic contact information for one or more prospective consumers. These prospective consumers may be contacted and invited to become a consumer. The existing consumer may thus receive a referral fee for any prospective consumers that complete the registration process. Contact information for prospective consumers may be imported from email address books and/or social and corporate networking websites.

The sales lead system may also include a means for connecting a consumer with existing social or business contacts. A contacts data location may be provided to store contact information for individuals in a consumer's social and/or business networks. A consumer may manually add contact information to the contacts data location for selected social or business contacts including name, email, address, phone number or other relevant contact information. An existing database of social or business contacts may also be integrated into the contacts data location. The contacts data may be populated by accessing an existing digital storage location containing data regarding the consumer's social and business networks. Information from the contacts data location may be utilized in a number of ways. As an example, a consumer may survey select individuals or all individuals from the contacts data location to obtain information regarding a particular provider. The consumer may seek feedback from individuals from the contacts data who may have purchased a good or service from a provider in the past. The contacts data location may also include information regarding which providers individuals in the consumer's social and business networks have purchased goods or services from in the past. The contacts data location may also provide a means for sharing a rating system where a consumer may view scores or feedback for providers that individuals in the consumer's networks have purchased from in the past.

More specifically, the contacts data location may be populated with a consumer's social and business networks from existing networks such as LinkedIn®, Facebook®, FourSquare®, Twitter®, or other networking sites. For example, upon “checking in” at a particular provider, a FourSquare user may have an option to provide their personal data to the provider via the present sales lead system. As with each of the networking sites above, the present sales lead system may also be available in a mobile application so that all steps and processes disclosed herein may be performed from a mobile device, including a cell phone, tablet device, or any other electronic means capable of communicating with a network.

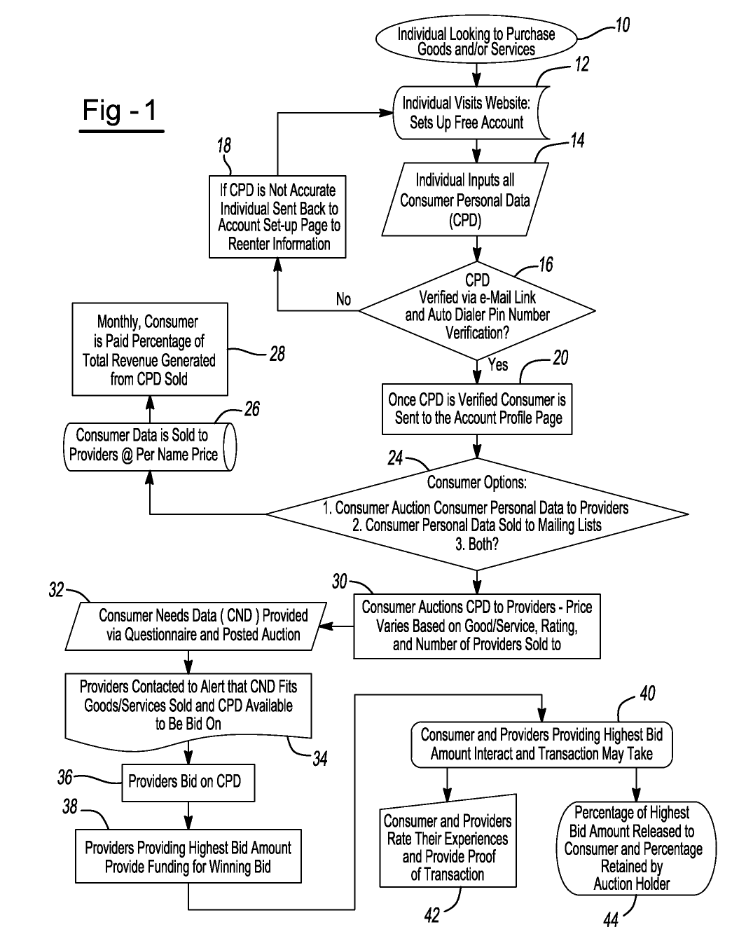

As shown for example in FIG. 1, an individual may arrive at a website, such as those disclosed herein, looking to purchase a good or service 10. The individual may register for a free account 12. The individual may populate their account information with consumer personal data 14. The individual may then be provided with an email link to verify the accuracy of all provided information 16. If the consumer personal data cannot be verified, the individual may be asked to re-enter the data 18. If the consumer personal data can be verified, the individual's account may be activated 20 and the individual is now qualified as a consumer. As a consumer, the consumer has three options 24. The consumer may auction their consumer personal data to multiple providers, sell their consumer personal data for use in mailing and/or calling lists, or the consumer may partake in both options. If the consumer sells their consumer personal data for use in mailing/calling lists, their consumer personal data may be sold to one or more providers 26 and the consumer may receive a portion of those proceeds 28. The consumer may alternatively or additionally auction their consumer personal data to providers 30, as provided herein. The consumer may then respond to a questionnaire 32 designed to determine with specificity the goods and/or services sought by the consumer (e.g., consumer needs data). Registered providers who provide the goods/and or services requested may then be contacted via email 34 to alert them to a possible auction opportunity. One or more providers may then bid on the consumer personal data 36. Any providers providing a highest bid amount may have the highest bid amount withdrawn from their account 38. The one or more providers may then correspond with the consumer whose personal data was purchased in an effort to reach an agreement on the purchase by the consumer of the goods and/or services sold by the provider 40. After a transaction either takes place or fails to take place, both involved providers and consumer provided results data regarding their experience 42. A portion of the highest bid amount may then be provided to the consumer 44.

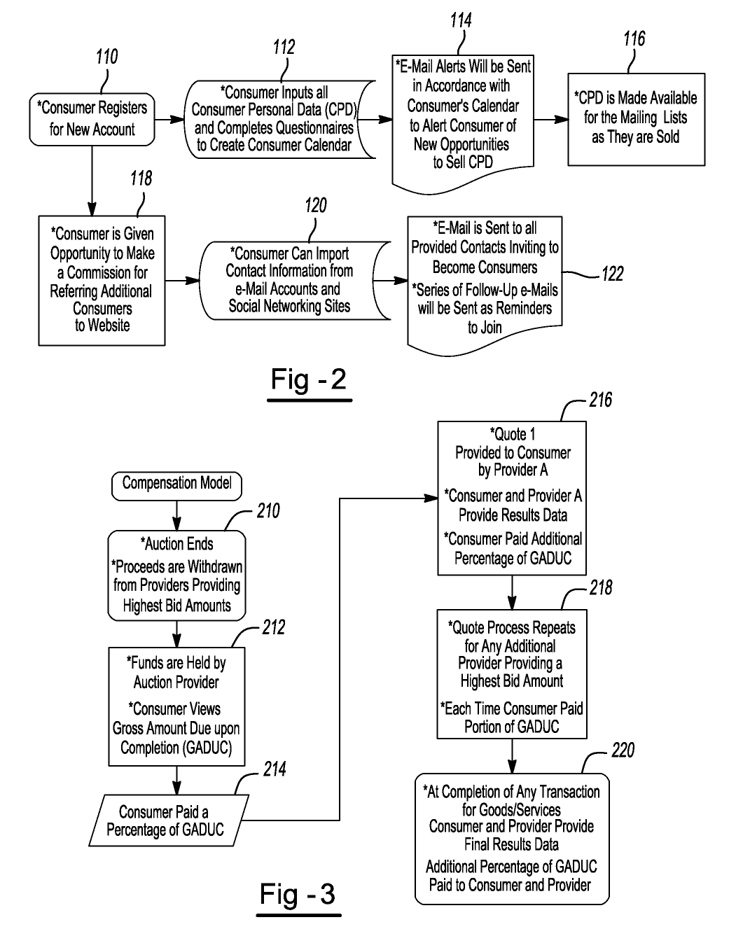

An example of the initial registration process for a prospective consumer is shown in FIG. 2. Once a consumer registers 110, consumer personal data may be provided via one or more forms or questionnaires 112. The consumer may choose to receive email correspondence alerting them to opportunities for providing their consumer personal data for mailing lists or for auction to providers 114. In the event that a consumer's consumer personal data is sold for mailing list purposes, the consumer may have access to such sales data 116. The consumer may also be provided with an opportunity to collect proceeds by referring new consumers to the website 118. The consumer may upload existing data from email programs or social networking websites to identify new consumers that may register for the site 120. An automated email system may send invitation emails and subsequent reminder emails 122 to all individuals identified by the consumer as possible new consumers. For all successful referrals (e.g., the referral results in a new consumer registration) the consumer may receive a referral fee.

An example auction compensation model is shown at FIG. 3. At auction end, all proceeds of highest bid amounts are withdrawn from the accounts of those providers providing those highest bid amounts 210. The funds may be held in escrow for a specified time period 212. The consumer may receive a portion of the highest bid amount 214. After receiving a quote from one or more providers providing a highest bid amount and successfully completing a results data questionnaire (both provider and consumer), the consumer may receive a percentage of each highest bid amount received (and thus each quote received) 216, 218. After completing a final results data questionnaire, the provider may receive a portion of the residual proceeds from any bid amount 220.

The sales lead system disclosed herein improves the current sales lead system by providing incentive to both consumers and providers. A consumer is incentivized to provide consumer personal data by receiving payment for the sale of their consumer personal data. A provider is incentivized by the increased chance that the lead has not been oversold and that the lead will result in a sale. The results reporting aspect of the system provides motivation to both consumers and providers to engage in more trustworthy business discussions.

Unless stated otherwise, while a feature of the present invention may have been described in the context of only one of the illustrated embodiments, such feature may be combined with one or more other features of other embodiments, for any given application.

The preferred embodiment of the present invention has been disclosed. A person of ordinary skill in the art would realize however, that certain modifications would come within the teachings of this invention. Therefore, the following claims should be studied to determine the true scope and content of the invention.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

1. A method for facilitating the exchange of consumer data between consumers and providers comprising the steps of:
collecting and storing consumer supplied data on a computer network, wherein one or more consumers:
i) provide needs data via a website, wherein the needs data relates to services or goods requested;
ii) provide personal data via website wherein the data relates to contact information;
iii) receive consumer scores based upon value of personal data, wherein the consumer scores are computer generated and based upon the consumer's likelihood of purchasing goods or services requested;
providing consumer supplied data to one or more providers, wherein one or more providers:
i) view needs data via a website of one or more consumers seeking services or goods provided by provider;
ii) view consumer scores via a website of one or consumers seeking services or goods provided by provider;
iii) provide bid amounts via a website for purchase of consumer personal data;
providing consumer personal data to provider providing highest bid amount;
collecting highest bid amount from provider having highest bid;
providing a portion of the collected bid amount to the consumer having personal data provided to provider having highest bid.

2. The method of claim 1, wherein a provider providing a highest bid provides results data via a website.

3. The method of claim 2, wherein the results data is positive results data if the consumer personal data received by the provider resulted in a purchase of goods or services from the provider or the results data is negative results data if the consumer personal data received by the provider did not result in a purchase of goods or services from the provider.

4. The method of claim 3, wherein the results data is used to generate consumer scores so that positive results data generates an increased consumer score and negative results data generates a decreased consumer score.

5. The method of claim 4, wherein a consumer having an increased consumer score results in that consumer receiving an increased portion of the collected bid amount.

6. The method of claim 1, wherein the highest bid amount is (i) refused by a consumer or (ii) accepted by a consumer.

7. The method of claim 1, wherein a consumer provides a suggested minimum bid amount via a website.

8. The method of claim 7, wherein any bid below the suggested bid amount is refused.

9. The method of claim 1, wherein one or more providers provide product data via a website, wherein the product data includes a list of goods and services provided by a provider.

10. The method of claim 4, wherein the consumer score reflects frequency of needs data provided by each consumer, frequency of positive results data for each consumer, frequency of negative results data for each consumer, accuracy of personal data provided by each consumer, or any combination thereof.

11. A website comprising:
a consumer interface accessed by one or more consumers wherein the consumer interface comprises:
i) a first data entry location wherein the data includes consumer needs data;
ii) a second data entry location wherein the data includes consumer personal data;
a provider interface accessed by one or more providers wherein the provider interface comprises:
i) a first data access location wherein the data includes consumer needs data;
ii) a second data access location wherein the data includes consumer scores;
iii) a bid entry location wherein the provider provides bid amounts in attempt to gain access to consumer personal data;
iv) a third data access location wherein only the provider providing the highest bid amount can access consumer personal data;
v) a results data entry location wherein the results data includes whether a consumer purchased goods or services from a provider.

12. The website of claim 11, wherein the consumer interface includes a third data entry location for providing a minimum bid amount requirement.

13. The website of claim 11, wherein the consumer interface includes a bid review location wherein a consumer can accept or refuse a bid amount.

13. The website of claim 11, wherein the consumer interface includes a data access location wherein the data includes consumer scores.

14. The website of claim 11, wherein the consumer interface includes a fourth data entry location for contesting any results data.

15. The website of claim 11, wherein the consumer interface includes a limited access option location wherein a consumer may limit the providers having an option to bid on a consumer's personal data.

16. The website of claim 11, wherein the consumer interface includes a proceeds access location wherein funds earned from a successful bid can be retrieved by a consumer.

17. The website of claim 11, wherein the consumer interface includes a contacts entry location wherein a consumer may store data relating to individuals in the consumer's social or business networks.

18. The website of claim 17, wherein the contact entry location can populate a consumer's contacts data by accessing an existing digital storage location containing data regarding a consumer's social or business networks.

19. The website of claim 17, wherein the consumer interface includes a survey location through which contacts data can be accessed and survey inquiries can be sent to a consumer's contacts.

20. A method for facilitating the exchange of consumer data between consumers and providers comprising the steps of:
providing product data via a website wherein the product data includes a list of goods and services provided by participating providers;
collecting and storing consumer supplied data on a computer network, wherein one or more consumers:
i) provide needs data via a website, wherein the needs data relates to services or goods requested;
ii) provide personal data via website wherein the data relates to contact information;
iii) receive consumer scores based upon value of personal data, wherein the consumer scores are computer generated and based upon the consumer's likelihood of purchasing goods or services requested;
providing consumer supplied data to one or more providers, wherein one or more providers:
i) view needs data via a website of one or more consumers seeking services or goods provided by provider;
ii) view consumer scores via a website of one or consumers seeking services or goods provided by provider;
iii) provide bid amounts via a website for purchase of consumer personal data;
providing consumer personal data to provider providing highest bid amount;
collecting highest bid amount from provider having highest bid;
providing a portion of the collected bid amount to the consumer having personal data provided to provider having highest bid;
collecting results data from provider providing a highest bid amount;
generating consumer scores based upon the results data.
